(19) United States
(12) Patent Application Publication
(10) Pub. No.: US 2026/0212383 A1
(43) Pub. Date: Jul. 23, 2026

(54) SYSTEMS AND METHODS FOR RESTRUCTURING PRICE RECORDS WHILE PRESERVING STATISTICAL DISTRIBUTIONS

(71) Applicant: MMS ANALYTICS, INC. DBA TALON, PORTSMOUTH, NH (US)

(72) Inventors: Mark Galvin, Portsmouth, NH (US); Jason Jeffords, Bedford, NH (US); Sean Kates, Portsmouth, NH (US); Caitlin Kates, Portsmouth, NH (US); Emily Higgins, Portsmouth, NH (US); Charlie Caldwell, Bridgewater, NH (US); Darryl Dietz, Rye, NH (US); Troy Payne, Dover, NH (US); Michael Jeffords, Manchester, NH (US); Brad Hicks, Deerfield, NH (US); Nikhil Bala, Nashua, NH (US); Matthew McCormick, Portsmouth, NH (US); Derek Spearing, Pocono Pines, PA (US)

(21) Appl. No.: 19/564,758

(22) Filed: Mar. 12, 2026

Related U.S. Application Data
(63) Continuation-in-part of application No. 19/004,362, filed on Dec. 29, 2024.
(60) Provisional application No. 63/689,790, filed on Sep. 2, 2024.

(51) Int. Cl. G06Q 30/0201; G06Q 20/14; G06Q 20/38

(52) U.S. Cl. CPC G06Q 30/0206; G06Q 20/14; G06Q 20/3829

(57) ABSTRACT

The present disclosure provides systems and methods for restructuring price records while preserving statistical distributions. The computer-implemented method includes receiving claims data from one or more data sources; and generating a plurality of statistical price records from the claims data to generate a set of first recommended price records. The computer-implemented method further includes receiving Machine-Readable Files (MRFs) and other pricing arrangements from the one or more data sources, and generating a plurality of direct price records from the MRFs and the other pricing arrangements to generate a set of second recommended price records. Furthermore, the computer-implemented method includes receiving, by the server system, one or more of payor rate overrides and provider rate overrides from one or more respective devices associated with one or more of a payor and a provider, respectively.

### TECHNICAL FIELD

The present disclosure relates generally to computer-implemented data processing systems for healthcare pricing data and, more particularly, to systems and methods for restructuring price records while preserving statistical distributions.

### BACKGROUND

Healthcare pricing information is generated and maintained across numerous heterogeneous computing systems, including insurance adjudication platforms, provider billing systems, pharmacy benefit systems, and medical device pricing repositories. Such systems produce large volumes of pricing data corresponding to healthcare services, procedures, pharmaceutical products, and medical devices. In aggregate, the resulting datasets comprise trillions of records represented in inconsistent formats, identifiers, and schemas. Because these records originate from independent sources and are stored using different data models, the data is frequently fragmented, redundant, and not directly comparable or efficiently processable.

Conventional techniques for handling such large-scale healthcare pricing datasets often require transferring and processing complete raw datasets, resulting in excessive storage consumption, high memory utilization, increased network bandwidth usage, and slow query performance. Additionally, naïve aggregation or reduction techniques may distort or eliminate underlying statistical characteristics of the pricing data, thereby degrading representativeness and accuracy. As a consequence, existing systems are unable to efficiently normalize and reduce large volumes of heterogeneous price records while maintaining statistical distributions necessary for reliable downstream computation and automated decision-making.

Accordingly, there exists a need for improved computer-implemented techniques that transform pricing datasets into a reduced set of standardized and statistically representative price records that preserve distributional characteristics of the original data while overcoming the aforementioned technical drawbacks.

### SUMMARY

Various embodiments of the present disclosure provide systems and methods for restructuring price records while preserving statistical distributions.

According to an aspect of the present disclosure, there is provided a computer-implemented method. The computer-implemented method includes receiving, by a server system, claims data from one or more data sources and generating statistical price records from the claims data. Furthermore, the computer-implemented method includes generating, by the server system, a plurality of statistical price records from the claims data to generate a set of first recommended price records. The set of first recommended price records are generated by: grouping the plurality of statistical price records into a plurality of first record groups according to a composite group matching key, selecting, for each first record group, a calculation method based on the composite group matching key, and applying the selected calculation method to records within the corresponding first record group to generate the set of first recommended price records from the plurality of statistical price records. The composite group matching key for a first record group is generated by combining one or more identifiers associated with each statistical price record within the corresponding first record group. The computer-implemented method further includes receiving, by the server system, Machine-Readable Files (MRFs) and other pricing arrangements from the one or more data sources. The computer-implemented method further includes generating, by the server system, a plurality of direct price records from the MRFs and the other pricing arrangements to generate a set of second recommended price records. The set of second recommended price records are generated by: grouping the plurality of direct price records into a plurality of second record groups according to a composite group matching key, selecting, for each second record group, a calculation method based on the composite group matching key, and applying the selected calculation method independently to the records within the corresponding second record group to generate the set of second recommended price records from the plurality of direct price records. The composite group matching key for a second record group is generated by combining one or more identifiers associated with each direct price record within the corresponding second record group. The computer-implemented method further includes receiving, by the server system, one or more of payor rate overrides and provider rate overrides from one or more respective devices associated with one or more of a payor and a provider, respectively. The computer-implemented method also includes generating, by the server system, universally acceptable price records based on the set of first recommended price records, the set of second recommended price records, the payor rate overrides, and the provider rate overrides.

According to another aspect of the present disclosure, there is provided a server system. The server system includes a processor, and a memory unit comprising machine-readable instructions, the machine-readable instructions when executed by the processor, cause the server system to at least receive claims data from one or more data sources. The server system is further caused to generate a plurality of statistical price records from the claims data to generate a set of first recommended price records. The set of first recommended price records are generated by: grouping the plurality of statistical price records into a plurality of first record groups according to a composite group matching key, selecting, for each first record group, a calculation method based on the composite group matching key, and applying the selected calculation method to records within the corresponding first record group to generate the set of first recommended price records from the plurality of statistical price records. The composite group matching key for a first record group is generated by combining one or more identifiers associated with each statistical price record within the corresponding first record group. The server system is further caused to receive Machine-Readable Files (MRFs) and other pricing arrangements from the one or more data sources. The server system is further caused to generate a plurality of direct price records from the MRFs and the other pricing arrangements to generate a set of second recommended price records. The set of second recommended price records are generated by grouping the plurality of direct price records into a plurality of second record groups according to a composite group matching key, selecting, for each second record group, a calculation method based on the composite group matching key, and applying the selected calculation method independently to the records within the corresponding second record group to generate the set of second recommended price records from the plurality of direct price records. The composite group matching key for a second record group is generated by combining one or more identifiers associated with each direct price record within the corresponding second record group. Furthermore, the server system is caused to receive one or more of payor rate overrides and provider rate overrides from one or more respective devices associated with one or more of a payor and a provider, respectively. The server system is also caused to generate universally acceptable price records based on the set of first recommended price records, the set of second recommended price records, the payor rate overrides, and the provider rate overrides.

### BRIEF DESCRIPTION OF THE FIGURES

For a more complete understanding of example embodiments of the present technology, reference is now made to the following descriptions taken in connection with the accompanying drawings:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a flow diagram depicting generation of universally acceptable prices based Machine-Readable Files (MRFs), in accordance with an embodiment of the present disclosure;

FIG. 4 illustrates a flow diagram depicting generation of universally acceptable price records, in accordance with an embodiment of the present disclosure;

FIG. 5 illustrates a flow diagram depicting a process for determining first recommended price records from statistical price records, in accordance with an embodiment of the present disclosure;

FIG. 6 illustrates a flow diagram depicting a process for determining second recommended price records from direct price records, in accordance with an embodiment of the present disclosure;

FIG. 7 illustrates a flow diagram depicting a process for determining the first recommended price or the second recommended price records for a given record group, in accordance with an embodiment of the present disclosure;

FIG. 8 illustrates a flow diagram depicting a process for selecting the universally acceptable price records from the first recommended price records, the second recommended price records, payor rate overrides, and provider rate overrides, in accordance with an embodiment of the present disclosure; and

FIG. 9 illustrates a flow diagram of a computer-implemented method for restructuring price records while preserving statistical distributions, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

It is important to note that the terms ‘employee’ and ‘insured’ have been used interchangeably throughout the description and these terms refer to a person availing insurance services provided by an employer. The term ‘employer’ refers to an entity or a company that provides healthcare benefits to their employees. The term ‘service provider’ refers to an entity that partners with the employer to provide healthcare management services to the employees. The term ‘medical service provider’ or ‘healthcare service provider’ refers to an entity that provides medical services for carrying out medical procedures. The term ‘benefits or incentives programs’ refers to employee benefits packages set up by the employer and/or the service provider as part of healthcare service offerings for the medical services availed by the employee. The term ‘insurance carrier’ or ‘payor’ refers to an entity that provides patient healthcare insurance coverage, a premium amount for the patient healthcare insurance coverage is paid for by the employer and/or the employee. The term ‘reference pricing’ (also referred to as ‘reference price benchmark’) can refer to a fair price benchmark for a medical service. Medical services at a medical service provider based on a reference price benchmark are determined by the value of the medical service. In some embodiments, the reference price benchmark is based on the value of the reference price or benchmark price. The reference price benchmark may also be determined based on employer benefits programs and medical claims data analysis in a user's region of service.

The price that a patient pays for a medical procedure or service is often based on a negotiated rate or contract price that is set between a medical services provider and an insurance carrier (i.e., payor). Depending on a patient's particular situation, the rate that a patient will pay for a medical procedure or service is based on the difference between the charge of the medical service provider and the contract price established between the medical service provider and the insurance carrier. The patient pricing is also affected by parameters and conditions set forth within a patient's insurance policy (i.e., plan) assuming a patient has one. To understand the process for setting prices for procedures and services, it is important to understand how medical procedures and services are paid in the current scenario.

Healthcare pricing information is increasingly available in digital and machine-readable formats, including adjudicated claims datasets and published negotiated rate files. These data sources collectively contain large volumes of records describing healthcare services, procedures, providers, facilities, and associated pricing information. The records are generated by multiple independent entities and stored using heterogeneous schemas and formats. Because these datasets originate from disparate systems, the pricing information is frequently fragmented, inconsistent, and redundant. The same procedure or service may appear in multiple records with differing identifiers, representations, or price values. As a result, direct comparison or aggregation of such datasets presents technical challenges related to normalization, deduplication, reconciliation, and large-scale processing.

To understand the amount that a patient pays for a particular medical procedure or service it is necessary to understand how the healthcare market is structured. The amount that a patient typically pays for a medical procedure or service is usually based on a series of calculations. Actual patient payments are often determined by limits and deductible amounts and percentages that are defined in a patient's insurance plan. Additionally, patient prices are based on contract rates set between medical services providers and insurance carriers. Patient prices vary based on the type of medical procedure or service that a patient receives. Procedure prices are also influenced by the types and locations of the medical facilities where procedures and services are received by patients. There are no regulatory standards in place to set commercial prices for medical procedures and services. Therefore, the development of patient and payor price models was initially based on post-adjudicated claims contained within a medical claims database. This database was initially developed based on insurance carriers' adjudicated claims. When only claims data is available, a nationwide universally acceptable pricing model requires data collection for all post-adjudicated claims from all insurance carriers.

Today, negotiated rates obtained from insurance carriers are primarily obtained from published Machine-Readable Files (MRFs). Negotiated rates are typically based on insurance carrier contract prices for all medical procedures and services that doctors, nurses, medical facilities laboratories, and pharmacies cover. Based on the Transparency in Coverage Rule and the Hospital Transparency Rule, insurance carriers and medical services providers are required to post MRFs of negotiated rates which are often described as “allowed amounts” or “adjusted rates” that are based on agreed-upon rates between buyers and sellers of medical procedures and services. The negotiated rates can be set before or after a medical procedure or service has been provided (but have an effective date). Once a statistically significant set of claims from all medical services providers and insurance carriers have been collected, it is possible to know what a payor has paid for a particular medical procedure or service. It is also possible to predict what the payor may pay in the future. Similarly, negotiated rates from MRF files can be used to know, and predict, what will be paid in the future.

The universally acceptable prices are derived from historical and current pricing data representing amounts paid or allowed by payors for corresponding medical procedures and services. The system aggregates negotiated rate information and adjudicated claims data across multiple medical service providers and insurance carriers to determine representative price values that are broadly applicable across the set of providers and payors. The resulting price values function as standardized reference prices that may be utilized in subsequent pricing or transactional processing.

The computation of statistical aggregates over negotiated rate datasets provides a foundational mechanism for generating universally acceptable price records. The representative price values are determined by computing one or more statistical measures, such as mean values, weighted averages, or other aggregation functions, over negotiated rate records associated with a given composite group matching key. It is recognized that a simple arithmetic average may not necessarily correspond to a minimum or lowest observed price for a medical procedure or service. Accordingly, additional statistical parameters, including total transaction counts, cumulative payment amounts, and claim volumes across providers and payors, may be incorporated into the aggregation process to derive uniform and statistically representative price values for each procedure or service type.

The increasing availability of publicly accessible healthcare pricing information, including negotiated rate data and coverage transparency datasets, has resulted in the generation of large-scale machine-readable files and claims repositories containing substantial volumes of heterogeneous pricing records. These datasets originate from multiple payors and providers and are published in varying formats, schemas, and levels of completeness. As a result, the disclosed data sources present significant technical challenges associated with ingestion, normalization, validation, deduplication, and reconciliation of inconsistent or incomplete records. The scale and variability of these datasets further necessitate distributed processing architectures, automated transformation pipelines, and structured aggregation techniques to enable reliable computation of standardized and statistically representative price records across geographically dispersed computing systems.

Various example embodiments of the present disclosure provide computer-implemented methods and systems for restructuring healthcare price records while preserving statistical distributions inherent in the underlying datasets. In particular, the disclosed techniques transform large volumes of heterogeneous pricing data into a reduced set of structured price records while maintaining the statistical behavior of the original data.

In some embodiments, claims data and machine-readable datasets corresponding to negotiated rates between health insurers and healthcare service providers are ingested and processed. From these datasets, two categories of price records are derived: (i) statistical price records generated from aggregated or distribution-based analysis of the claims data, and (ii) direct price records obtained from negotiated rate data or explicitly defined pricing information. These price records are further processed to restructure and standardize the underlying data representations.

Claims data is used to develop statistical price records and publicly available Machine-Readable Files (MRFs) and other pricing arrangements are used to create direct price records. Claims data includes structured healthcare transaction records that are programmatically ingested and processed by the server system and records the details of healthcare services provided to individuals and the associated pricing information. Claims data typically includes normalized identifier such as patient information (name, ID, etc.), provider information (name, NPI), healthcare services rendered (codes), dates of service, and costs (charges, payments, adjustments). The MRFs provide standardized machine-readable data representing negotiated rates between health insurers and healthcare service providers. The MRFs include negotiated in-network rates for services, historical out-of-network allowed amounts, and negotiated rates and historical net prices for prescription drugs. The statistical price records and the direct price records are then processed and combined with payor overrides and provider overrides to generate structured and reconciled price values. The provider overrides may refer to overrides presented by any one or both of the service providers and the healthcare service providers.

The collected RFs, claims data, payor overrides, and provider overrides are used to generate optimized HSP price records and optimized pharmacy price records. For the generation of optimized HSP price records and optimized pharmacy price records order of precedence between the statistical price records, the direct price records, the payor overrides, and the provider overrides may depend upon several factors such as a facility where a medical procedure or service is provided by a doctor or nurse (i.e., the HSP), the service provider, the HSP, the place of service, the procedure code, the procedure modifiers, the institutional or professional class, etc. The generated optimized HSP price records and optimized pharmacy price records are used to generate universally acceptable prices based MRFs that include universally acceptable prices which act as a reference for the service providers, the HSPs, the payors, the patients, and/or the employers of the patients as agreeable healthcare prices.

During restructuring, each price record (statistical/direct price record) is grouped into one of a plurality of record groups based on a composite group matching key. The composite group matching key may be generated using normalized identifiers such as procedure codes, provider identifiers, geographic indicators, or other pricing-relevant attributes corresponding to records within the group. For each record group, a corresponding calculation method is selected based on characteristics of the grouped data represented by composite group matching key. The selected calculation method is then applied to the records within the corresponding group to generate a set of first recommended price records derived from the statistical price records. Similarly, direct price records are processed using corresponding calculation logic to generate a set of second recommended price records.

Upon generation of the first recommended price records and the second recommended price records, the system generates a machine-readable file comprising a universally acceptable price record. The universally acceptable price record is constructed based on the first recommended price records, the second recommended price records, applicable payor rate overrides, and provider rate overrides. The machine-readable file is structured for automated storage, indexing, transmission, and downstream transactional processing.

The generation of the first recommended price records and the second recommended price records facilitates restructuring and consolidation of large-scale pricing datasets into a reduced, standardized representation. This restructuring significantly decreases storage requirements and computational overhead while preserving the statistical properties of the original pricing data, thereby maintaining representativeness and distributional fidelity.

Therefore, the present invention facilitates transformation of the large and heterogeneous healthcare pricing datasets into statistically representative and structurally consistent price records without transferring or storing the entirety of the raw data. By grouping records using composite keys and applying group-specific calculation methods, the system achieves deterministic normalization and data reduction while maintaining statistical distributions necessary for accurate automated processing.

Moreover, the resulting universally acceptable price records enable efficient indexing, rapid key-based retrieval, and reliable integration into automated transactional workflows. Because the reduced price records preserve distributional characteristics of the underlying data, the system supports scalable storage, minimized bandwidth utilization, improved query performance, and enhanced integrity in downstream pricing validation and payment processing operations.

The preserving statistical distributions refer to maintaining one or more quantifiable statistical properties of the underlying price records when generating the reduced universally acceptable price records. Such statistical properties may include, without limitation, measures of central tendency (e.g., mean, median), measures of dispersion (e.g., variance, standard deviation, interquartile range), weighted contribution proportions (e.g., claim volume weighting), frequency distributions, and percentile rankings associated with a given price record. During restructuring, the system computes statistical aggregates over the full set of records within each record group and generates a reduced price record that encodes a representative value derived from those aggregates. The system may further store metadata associated with each reduced record i.e. universally price acceptable record indicating the underlying sample size, weighting factors, dispersion metrics, or validity interval. By computing group-level statistical measures prior to reduction and deriving reduced records directly from those computed measures, the system ensures that the statistical behavior of the original dataset is mathematically preserved at the group level, even though the total number of stored records is reduced.

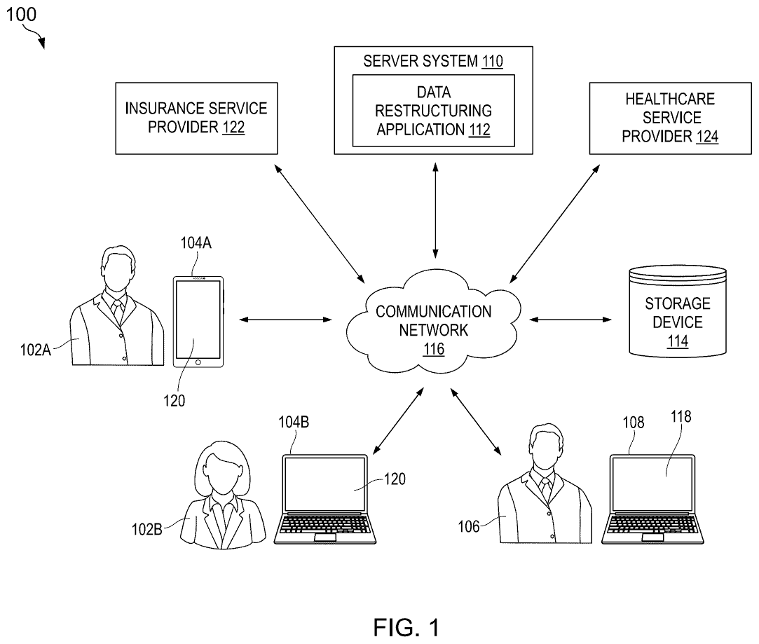

Various example embodiments of the present disclosure are described hereinafter with reference to FIG. 1 to FIG. 9.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, restructuring price records while preserving statistical distributions, and the like.

The environment 100 generally includes a plurality of entities, such as a server system 110, a plurality of users 102A, 102B, and 106, a plurality of electronic devices 104A, 104B, and 108, an insurance service provider 122, a healthcare service provider 124, and a storage device 114, each coupled to, and in communication with (and/or with access to) a network 116 (also referred as a communication network 116). The plurality of users 102A, 102B, and 106 includes a user 102A, a user 102B, and a user 106. The user 102A (also referred to as an ‘employee 102A’) is depicted to be associated with an electronic device 104A (also referred to as an ‘employee device 104A’), the user 102B (also referred to as an ‘employee 102B’) is depicted to be associated with an electronic device 104B (hereinafter also referred to as an ‘employee device 104B’), and the user 106 (also referred to as an ‘employer 106’) is depicted to be associated with an electronic device 108 (as referred to as an ‘employer device 108’). The electronic device 104A is exemplarily depicted as a smartphone, and the electronic devices 104B and 108 are exemplarily depicted as laptops.

It is understood that the electronic devices 104A, 104B, and 108 of the users 102A, 102B, and 106, respectively, may be any of the devices such as a mobile phone, a computer, a PDA (Personal Digital Assistant), a Mobile Internet Device (MID), a tablet computer, an Ultra-Mobile Personal Computer (UMPC), a tablet computer, a handheld personal computer and the like. In an embodiment, the employer 106 may decide to provide healthcare and insurance benefits to its employees and thus prefer services and work with the insurance service provider 122 to set up a benefit program for the employees (such as the employees 102A and 102B). The benefit programs will be utilized by the employees 102A and 102B to avail healthcare and insurance benefits.

In at least one example embodiment, the server system 110 provides a software application, referred to herein as a data restructuring application 112 used to transform heterogeneous price records into structured and statistically representative price records, in response to user requests received from the electronic devices 104A, 104B and 108 via the network 116. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 116 may utilize a secure protocol (e.g., Hypertext Transfer Protocol (HTTP), Secure Sockets Layer (SSL), Transport Layer Security (TLS), and/or any other protocol, or set of protocols for communicating with the various entities depicted in FIG. 1.

In an embodiment, the data restructuring application 112 may be factory-installed on the electronic devices 104A, 104B, and 108 and the users 102A, 102B, and 106 may not need to specifically request data restructuring application 112 from the server system 110. In another embodiment, the electronic devices 104A, 104B, and 108 may access an instance of the data restructuring application 112 from the server system 110 for installation on the electronic devices 104A, 104B, and 108 using application stores such as Google Play Store managed by Google®, Apple app store managed by Apple®, Amazon store managed by Amazon®, and the like.

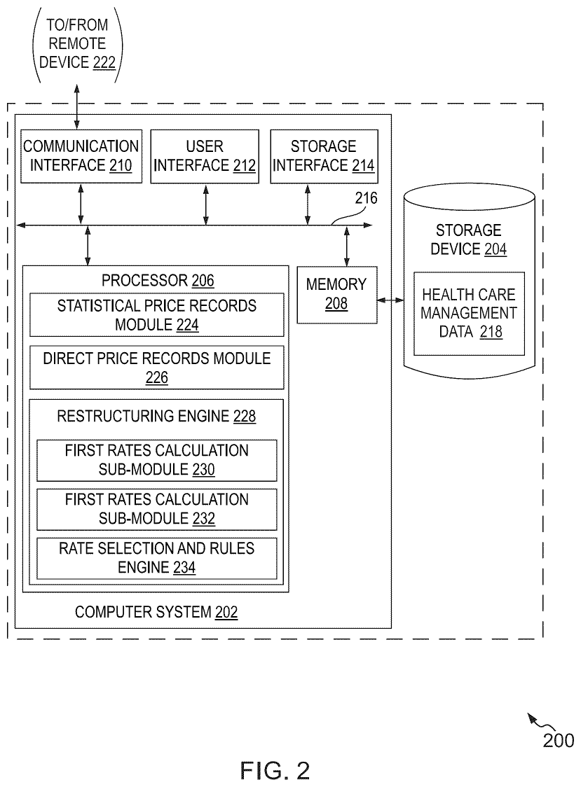

The server system 110 may be a local and a physical server present at a geographical location. Alternatively, or additionally, the server system 110 can be a remote server, such as a cloud-based server. The server system 110 may be a server associated with a third-party service provider responsible for processing healthcare pricing data. Further, the server system 110 may be a server associated with a third-party service provider, which provides insurance services on behalf of employers to their employees. Alternatively, the server system 110 may be a server controlled by the employer, such as the employer 106. The server system 110 also has access to a storage device 114 to store, retrieve, and manage large-scale pricing datasets, normalized price records, indexes, and machine-readable files generated during processing. The server system 110 includes a memory and one or more processors. The memory includes instructions for processing data. The processor executes the instructions stored in memory and facilitates the server system 110 to perform normalization, grouping, restructuring, and transformation of healthcare price records. It is to be noted that the various operations of the server system 110 have been described in detail later with reference to FIG. 2.

In an embodiment, the server system 110 may be used to process large volumes of healthcare pricing data received from multiple data sources and transform the data into standardized and reduced price records, which may be provided to the users 102A and 102B (such as the employees 102A and 102B). The server system 110 may selectively transmit the reduced price records to remote nodes (e.g., other servers, cache nodes, or distributed computing devices etc.), to synchronize distributed pricing caches while avoiding transfer of complete raw datasets. The server system 110 for restructuring the price records may be implemented by an employer (such as the employer 106), an insurance company (such as the insurance service provider 122), or any other entity as described above. For example, an employer (such as the employer 106) seeking to restructure price records to be provided to its employees (such as the employees 102A and 102B) may use the server system 110 to keep track of data pertinent to the healthcare plans of its employees (such as the employees 102A and 102B).

In at least one example embodiment, the data restructuring application 112 is configured to ingest, normalize, and restructure healthcare pricing data using data received from a database maintained in the storage device 114 and data collected from other sources. In an embodiment, the data restructuring application 112 may provide an employer interface 118 on the employer device 108 associated with the employer 106 for configuring data ingestion parameters, grouping rules, and record generation settings. In some example embodiments, data restructuring application 112 may provide employee interfaces 120 on the employee devices 104A and 104B. The employee interfaces 120 may be used by the employees 102A and 102B for getting medical benefits and incentives based on the employer's program set up by the employer 106. The data restructuring application 112 may have appropriate rights to shield an employer's program from another employer.

In at least one example embodiment, the data restructuring application 112 is configured to determine a reference pricing for a medical service required by the employee, such as the employee 102A. The reference pricing sets an upper limit based on a fair price considered or determined for the medical service. The reference pricing is set based on the medical benefits program opted by the employer 106, analysis of direct price data contained in Machine Readable Files (MRFs), historical claim prices of the medical service in a region of the employee, and statistical analysis on raw claims data. The reference price is derived from the universally acceptable price records generated by the restructuring engine, which indicate a reduced and standardized data structure. The resulting reference price values can be used as baseline or threshold price values during subsequent pricing or transactional processing.

In an embodiment, the employee interface 120 may display a list of healthcare service providers (e.g., healthcare service providers 124) available in the region of the employee (e.g., the employee 102A) providing the medical service required by the employee and delivered by the healthcare service provider 124 in decreasing order of the value of medical benefits and incentives for the user/employee (e.g., the employee 102A). The list of healthcare service providers 124 may also be filtered based on additional criteria such as region, distance, and/or insurance provider. The user/employee (e.g., the employee 102A) can choose any healthcare service provider from the list of healthcare service providers (e.g., healthcare service providers 124) to avail the medical service. The medical benefits and incentives for the healthcare service providers 124 (i.e., medical service/medical service provider) are determined and provided to the user (e.g., the employee 102A).

In an embodiment, the medical benefits and incentives provided to a user (e.g., the employee 102B) may be applied to one or more accounts associated with the user (e.g., the employee 102B) based on account prioritization set by the employer 106 and benefits and incentives limits set per account as per legal constraints. A set of priority levels is used to prioritize the application of benefits and incentives to user accounts. At each priority level (e.g., level 1 through level 4), there may be an associated account. The priority level for the accounts is defined in the employer benefits and incentives program associated with the user (e.g., the employee 102B). The priority level determines the order in which an employee's accounts are debited or credited.

The data restructuring application 112 is an application/tool resting at the server system 110. In an embodiment, the server system 110 is configured to host and manage the data restructuring application 112 and communicate with user devices, such as the electronic devices (e.g., 104A, 104B, and 108) for providing an instance of the data restructuring application 112. In an embodiment, the server system 110 may be coupled to the storage device 114. In one embodiment, the storage device 114 may be incorporated in the server system 110, or maybe an individual entity connected to the server system 110 or maybe a cloud-based storage device. In various non-limiting examples, the storage device 114 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 110 with access to the storage device 114. In one implementation, the database maintained in the storage device 114 may be viewed, accessed, amended, updated, and/or deleted by an administrator (not shown) associated with the server system 110 through a database management system (DBMS) or Relational Database Management System (RDBMS) present within the storage device 114. In several alternate embodiments, the database may be maintained in other forms such as a vector database or a graph database without departing from the scope of the disclosure.

It should be understood that the server system 110 may be a separate part of the environment 100, and may operate apart from (but still in communication with, for example, via the network 116) any third-party external servers (to access data such as the training datasets to perform the various operations described herein). However, in other embodiments, the server system 110 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 110 should be understood to be embodied in at least one computing device in communication with the network 116, which may be specifically configured, via executable instructions, to perform steps as described herein, and/or embodied in at least one non-transitory computer-readable media.

The server system 110 uses localized market information, the universally acceptable prices, plan pricing determined from raw claims data, MIRFs, individualized benefits and incentives program design information, employer program control information, information related to benefits, and incentives debited or credited to health plan accounts (e.g., Health Services Accounts (HSAs), Health Reimbursement Accounts (HRAs), and Flexible Spending Accounts (FSAs)), point information, and non-monetary benefits information (e.g., coupons, memberships). After incentive programs are designed and selected, all program administration is automatic. The server system 110 includes various sub-processors or modules that can be implemented using one or more processors for managing healthcare pricing records.

FIG. 2 illustrates a simplified block diagram of a server system 200, in accordance with an embodiment of the present disclosure. The server system 200 is identical to the server system 110 of FIG. 1. In some embodiments, the server system 200 is embodied as a cloud-based and/or SaaS-based (software as a service) architecture.

The server system 200 includes a computer system 202 and a storage device 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities. The processor 206 includes without limitation a single-core or a multi-core processor.

In some embodiments, the storage device 204 is integrated into the computer system 202. In one embodiment, the storage device 204 is substantially similar to the storage device 114 in FIG. 1. In one non-limiting example, the storage device 204 is configured to store healthcare management data 218. The healthcare management data 218 includes but is not limited to medical benefit programs specific to an employer (e.g., the employer 106), account details of the users (e.g., the users 102A, 102B, and 106), and data related to healthcare services. The data related to healthcare services includes but is not limited to, reference price lists, direct price data, historical claim prices, statistical analysis data, and healthcare and medical service providers data.

The medical benefit programs include but are not limited to the programs designed by the healthcare service provider 124 based on the health insurance plans of the employer. Health insurance plans provided by employers may vary with regard to covered procedures, drugs, health aids, medical examinations, coverage amounts, and so on. In one embodiment, the health insurance plans may include an annual individual and/or family deductible that needs to be satisfied before benefit payments are made. In some embodiment, the health insurance plans may require an insured person (e.g., an employee) to pay a percentage of the insurance amount and the remainder amount needs to be paid by the insurance institution. The server system may store and process these plan-specific parameters as structured data fields and may utilize the parameters during price determination or transactional processing to compute payable amounts or responsibility allocations associated with a given medical service.

The account details of the users 102A, 102B, and 106 include but are not limited to login details, employee codes, medical benefits program, employees associated with the employer, plan type (individual or family), and so on. The reference pricing (also referred to as “universally acceptable pricing”) includes a set based on employer programs, historical claim prices for medical services based on where users are located, and statistical analysis of raw claims data. The direct price data includes price data contained in Machine Readable Files (MRFs). The Machine-Readable Files (MRFs) are generally sourced from insurance carriers (i.e., payors) and hospitals and typically represent negotiated rate data. The historical claim prices indicate the prices claimed by the insured person related to healthcare services provided by healthcare service providers over a period of time. The raw claims data includes a set of claims from all medical service providers and insurance carriers that have been collected for a particular medical procedure or service. The healthcare and medical service provider data includes data related to all medical procedures and services that doctors, nurses, medical facilities, laboratories, and pharmacies cover.

In a non-limiting example, the database 204 includes an Artificial Intelligence (AI) or Machine Learning (ML) model. The AI/ML model may be used in the creation and management of the facility/provider data set (for example, the healthcare management data 218) and in the processing of natural language plan documentation. In one embodiment, the AI/ML may be used during the data cleaning and filtering stages.

Further, the computer system 202 may include one or more hard disk drives as the storage device 204. The user interface 212 is an interface, such as a Human Machine Interface (HMI) or a software application that allows users such as administrators to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the storage device 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the storage device 204.

The processor 206 includes suitable logic, circuitry, and/or interfaces to execute operations for restructuring the pricing records, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure. It should be noted that the data restructuring application 112 as depicted in FIG. 1 may be incorporated in the memory 208 or the storage device 204 of the server system 200.

The processor 206 is operatively coupled to the communication interface 210, such that the processor 206 is capable of communicating with a remote device 222, such as electronic devices 104A, 104B, 108 of the users 102A, 102B, and 106, or communicating with any entity connected to the network 116 (as shown in FIG. 1). It is to be noted that the server system 200 as illustrated and hereinafter described is merely illustrative of an apparatus that could benefit from embodiments of the present disclosure and, therefore, should not be taken to limit the scope of the present disclosure. It is to be noted that the server system 200 may include fewer or more components than those depicted in FIG. 2.

It is to be noted that the instructions (or the executable code) configuring the data restructuring application 112 are stored in the memory 208 of the server system 200, and the instructions are executed by the processor 206 included within the server system 200. Accordingly, even though the various functionalities for restructuring price records are explained with reference to or being performed by the data restructuring application 112, it is to be understood that the processing module in conjunction with the instructions stored in the memory 208 is configured to execute the various tasks as enabled by the instructions of the data restructuring application 112.

In one implementation, the processor 206 includes a statistical price records module 224, a direct price records module 226, and a restructuring engine 228. The restructuring engine 228 further includes a first rates calculation sub-module 230, a second rates calculation submodule 232, and a rate selection and rules engine 234. It should be noted that components, described herein, such as the statistical price records module 224, the direct price records module 226, the restructuring engine 228, the first rates calculation sub-module 230, the second rates calculation submodule 232, and the rate selection and rules engine 234 can be configured in a variety of ways, including electronic circuitries, digital arithmetic, and logic blocks, and memory systems in combination with software, firmware, and embedded technologies. Moreover, it may be noted that the statistical price records module 224, the direct price records module 226, the restructuring engine 228, the first rates calculation sub-module 230, the second rates calculation submodule 232, and the rate selection and rules engine 234 may be communicably coupled with each other to exchange information with each other for performing the one or more operations facilitated by the server system 200.

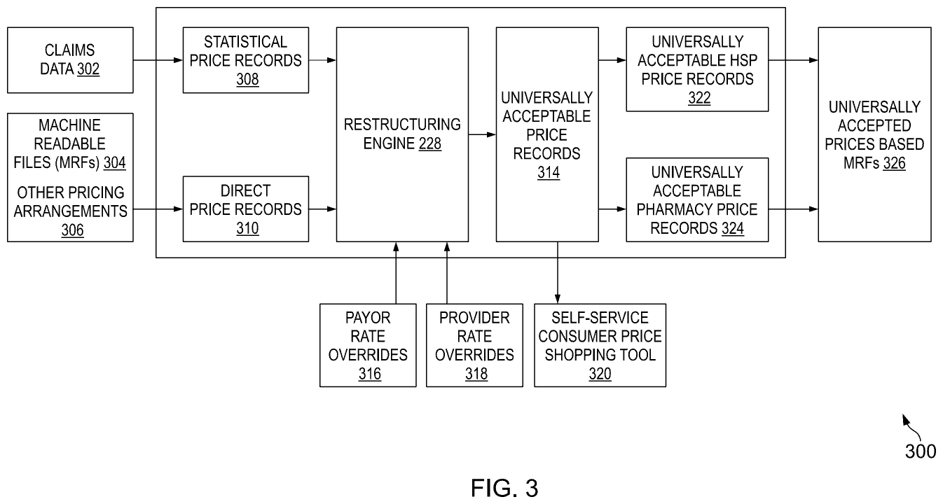

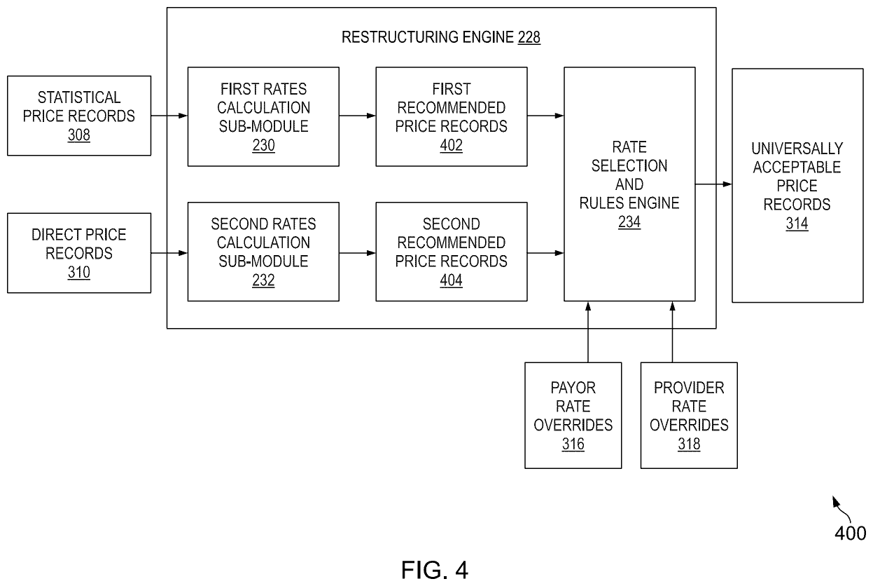

FIG. 3 illustrates a flow diagram 300 depicting generation of universally acceptable prices based Machine-Readable Files (MRFs) 326, in accordance with an embodiment of the present disclosure. FIG. 4 illustrates a flow diagram 400 depicting generation of universally acceptable price records 314, in accordance with an embodiment of the present disclosure. Referring to FIGS. 2, 3, and 4, the statistical price records module 224 is configured to receive claims data 302 and generate statistical price records 308 from the claims data 302 (See FIG. 3). In that regard, the statistical price records 308 may include mean, median, and standard deviation of charges and payments, payment-to-charge ratios, price trends over time, geographic variations, and comparison with benchmarks (e.g., national averages, regional averages, etc.).

The claims data 302 may be derived from a variety of sources including insurance providers (represents a primary source of closed claims data) and typically includes medical and pharmacy transactions generated during a specific period of time. The claims data 302 may provide a detailed picture of a patient's healthcare journey and total cost of care. The claims data 302 may also be sourced from large state databases that are developed from a collection of medical, pharmacy, and dental claims, and also from eligibility and provider files from private and public payers. Insurers typically have to report claims to states where the claims accumulate.

It is also possible to get the claims data 302 from government sources, for example, Medicare of the United States of America. The claims data 302 may also be sourced from clearinghouses, pharmacies, and potentially from software platforms such as claims adjudication systems. Such sources provide post-adjudicated claims data 302 and highlight a patient's healthcare over a period of time. The MRFs 304 are generally sourced from insurance carriers (i.e., payors) and hospitals and typically represent negotiated rate data.

Key steps involved in the generation of statistical price records 308 from the claims data 302 may include, but are not limited to, data cleaning and preparation (removing duplicates, handling missing values, standardizing data, creating relevant variables (such as procedure codes, diagnosis codes, provider identifiers, payor identifiers, dates of service, charges, payments, discounts, adjustments, etc.)), aggregating data (grouping by variables, calculating summary statistics for each group (such as mean, median, maximum and minimum charges, standard deviation, total volume, average payment, payment to charge ratio)), adjusting for inflation (applying inflation index (e.g., consumer price index)), considering geographic variation, control for covariates, analyzing price trends, and generating summary tables and visualizations.

The direct price records module 226 is configured to receive MRFs 304 and other pricing arrangements 306 and generate direct price records 310 from the MRFs 304 and the other pricing arrangements 306 (See FIG. 3). The other pricing arrangements 306 may include, but are not limited to, Fee-for-Service (FFS) (HSPs are paid for individual service or procedure rendered), bundled payments (a fixed amount is paid for a group of related services to the HSPs), capitation (HSPs receive a fixed payment per member per month, regardless of services rendered), salary (HSPs are paid a fixed salary, regardless of services rendered), Pay-for Performance (PFP) (HSPs are rewarded for achieving specific quality or efficiency metrics), and hybrid models (a combination of different pricing arrangements).

Key steps in the generation of the direct price records 310 may include, but are not limited to, extracting relevant data from the MRFs 304 (negotiated-in-network rates, historical out-of-network allowed amounts, and negotiated rates for prescription drugs) and the other pricing arrangements 306 (pricing information from contracts or agreements (e.g., bundled payments, capitation, etc.)), standardizing extracting data (such as generating a format including procedure codes, diagnosis codes, provider identifiers, payor identifiers, dates of services, prices paid (negotiated rates, allowed amounts, etc.)), adjusting for pricing arrangements (for example, in bundled payments, the price might be for a group of services rather than individual procedures), addressing geographic variations, and benchmarking.

The restructuring engine 228 receives the statistical price records 308 and the direct price records 310 as inputs. Furthermore, the restructuring engine 228 receives payor rate overrides 316 and provider rate overrides 318 also as inputs. In that regard, the restructuring engine 228 may receive the payor rate overrides 316 from a device associated with an insurance carrier, the entity that provides the insurance coverage. The provider rate overrides 318 may refer to any one or more of the overrides provided by the HSPs or the entity that partners with the employer to provide healthcare record management services. In that regard, the restructuring engine 228 may receive the provider rate overrides 318 from one or more respective devices associated with one or both of the insurance service provider 122 and the healthcare service provider 124. The restructuring engine 228 is further configured to generate universally acceptable price records 314 based on the direct price records 310, the statistical price records 308, the payor rate overrides 316 and the provider rate overrides 318. In an embodiment, the restructuring engine 228 aggregates, reconciles, and consolidates these inputs to generate universally acceptable price records 314 i.e. a standardized and canonical set of price records that represent the pricing information in a consistent and machine-readable format. As a result, the restructuring engine 228 restructures and reduces the overall volume of pricing data by consolidating multiple heterogeneous or redundant records into a smaller number of standardized records while preserving statistical characteristics of the original dataset. This reduction decreases storage requirements, improves indexing and retrieval efficiency, and enables deterministic and scalable downstream processing without loss of distributional fidelity.

In several embodiments of the invention, the universally acceptable price records 314 can include universally acceptable HSP price records 322 and universally acceptable pharmacy price records 324 in addition to auxiliary data needed to power a self-service consumer price shopping tool 320 mandated using a price transparency final rule, set by an authority/agency that administers healthcare programs of a state (e.g., a country). The final rules, set forth requirements for group health plans and health insurance issuers in the individual and group markets, to disclose cost-sharing information upon request to a participant, beneficiary, or enrollee (or his or her authorized representative), including an estimate of the individual's cost sharing liability for covered items or services furnished by a particular provider. The auxiliary data needed to power the self-service consumer price shopping tool 320, and included in the universally acceptable price records 314, may include one or more of, but is not limited to, Healthcare Common Procedure Coding System (HCPCS) codes including Current Procedural Terminology (CPT) codes and additional codes for non-physician services like ambulance transport and durable medical equipment, Diagnosis-Related Group (DRG) codes, Revenue (RC) codes, directory of healthcare providers with locations and contact information, provider specialties and qualifications, health plan formularies, plan details, network coverage, hospital quality ratings, provider performance data, patient reviews and ratings, etc. The aforementioned auxiliary data needed to power the self-service consumer price shopping tool 320, the universally acceptable HSP price records 322 and the universally acceptable pharmacy price records 324 may be used by the pricing engine to generate the self-service consumer price shopping tool 320. The universally acceptable HSP price records 322 and the universally acceptable pharmacy price records 324 are further used by the restructuring engine 228 to generate universally acceptable prices based RFs 326. Thus, the universally acceptable prices based RFs 326 are the resultant output from a data ingestion process that begins with the claims data 302, RFs 304, and the other pricing arrangements 306.

In an embodiment, once the universally acceptable price records 314 are generated by the restructuring engine, the restructuring engine 228 selectively transmits only the universally acceptable price records 314 i.e. a reduced data representation of the underlying pricing datasets to one or more remote computing nodes to synchronize distributed pricing caches, while avoiding transfer of the underlying statistical price records 308, direct price records 310, or other raw datasets. The transmitted records are packaged in a compact, machine-readable format and communicated over the network to the remote nodes.

Upon receipt at a remote node, the universally acceptable price records 314 are written into local memory or persistent storage and used to populate or update a local pricing cache. The remote node replaces or invalidates stale cache entries corresponding to matching composite group matching keys and inserts the newly received records into the cache. The remote node may further generate or refresh local index structures, such as hash tables or B-tree indexes, keyed by the composite group matching keys to enable constant-time or near constant-time retrieval. Subsequent pricing or transaction requests are serviced directly from the locally stored cache without querying centralized datasets, thereby reducing network input/output operations, lowering latency, and improving processing throughput.

In an embodiment, once the universally acceptable price records 314 are generated by the restructuring engine, the restructuring engine 228 generates an index for the universally acceptable price records by computing the composite group matching key for each universally acceptable price record and storing the records in an indexed data structure keyed by the composite group matching key. In some embodiments, the server system allocates memory to construct a hash table, B-tree, or similar key-addressable structure, and inserts each universally acceptable price record into the structure by associating the composite group matching key with a corresponding memory address or storage offset of the record. Upon receiving a pricing or transaction request, the server system computes a corresponding composite group matching key and performs a direct key-based lookup in the indexed data structure to retrieve the associated universally acceptable price record without scanning the full dataset, thereby enabling constant-time or near constant-time retrieval and reducing processor cycles, and query latency.

In another embodiment, in response to receiving a user request or pricing request, the server system is configured to scan the universally acceptable price records 314 corresponding to a composite group matching key identified through the request. The server system computes the composite group matching key from request parameters and identifies a corresponding subset of universally acceptable price records stored within a local cache or persistent storage. The server system then sequentially accesses the memory locations or storage offsets associated with the identified subset and iteratively reads the records to extract, compare, or evaluate the relevant price values.

In an embodiment, the server system is further configured to automatically facilitate a payment transaction by generating a machine-readable payment instruction message based on a payable amount derived from the universally acceptable price records 314. Upon retrieving a corresponding universally acceptable price record for a requested procedure or service, the server system computes the payable amount by applying applicable quantities, adjustments, or modifiers to the retrieved price value and writes the computed amount into a structured payment instruction data object. The server system serializes the payment instruction data object into a machine-readable format, such as a structured message, transaction packet, or electronic funds transfer (EFT) request, including fields specifying at least a payee identifier, payer identifier, transaction amount, and transaction reference information. The server system may then transmit the serialized payment instruction message over a network interface to an external payment processing system, which receives and executes the instruction to initiate settlement of the transaction. By automatically generating and transmitting the payment instruction message directly from the retrieved universally acceptable price records, the server system eliminates manual intervention, reduces processing latency, and enables deterministic, programmatic execution of payment operations.

In an embodiment, the server system is further configured to abort a transaction upon detection of a mismatch between a submitted price value included in a transaction request received by the server system and a corresponding universally acceptable price retrieved from the universally acceptable price records 314. Upon receiving a pricing or payment request, the server system retrieves the applicable universally acceptable price record using the composite group matching key and loads the retrieved price value into memory. The server system then performs a comparison operation between the submitted price and the retrieved price value. If the values differ beyond a defined threshold, the server system generates a mismatch condition and programmatically terminates the active transaction by cancelling pending write operations, discarding any staged updates in a transaction buffer, and preventing commitment of the transaction to persistent storage. In some embodiments, the server system rolls back the transaction state to a previously committed snapshot, releases associated locks, and returns an error or rejection message to the requesting device. By halting execution and preventing propagation of inconsistent pricing data, the server system maintains data integrity, avoids invalid record updates, and ensures that only transactions consistent with the universally acceptable price records are committed.

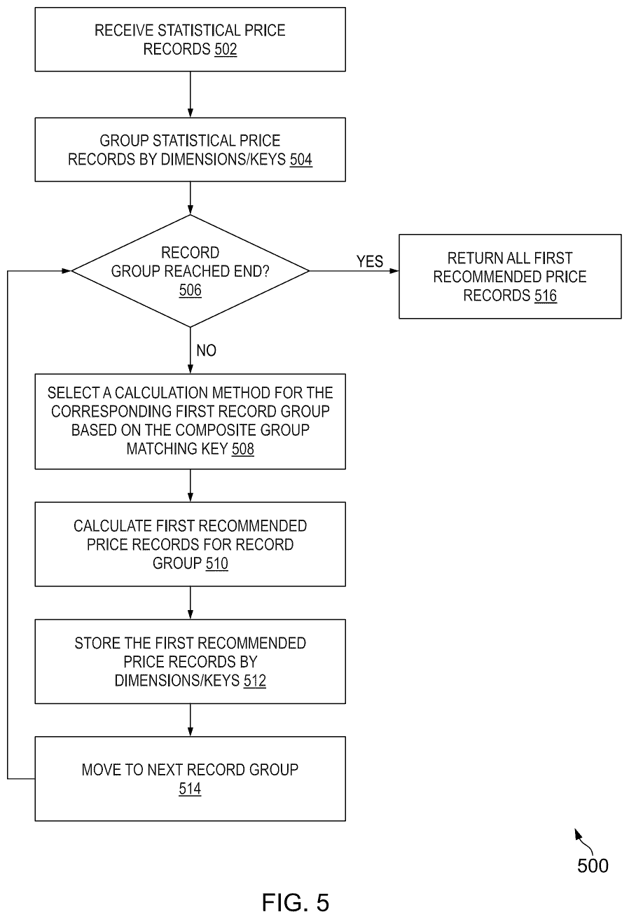

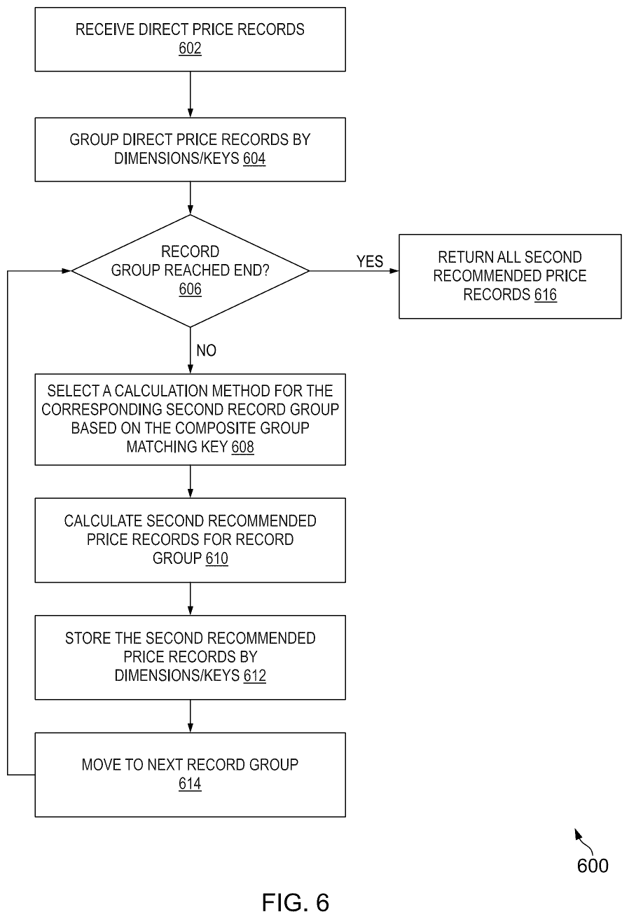

Referring to FIG. 4, the first rates calculation submodule 230 is configured to receive the statistical price records 308 as input and generate a set of first recommended price records 402. The second rates calculation submodule 232 is configured to receive the direct price records 310 as input and generate a set of second recommended price records 404. It is to be noted that the various operations of the first rates calculation submodule 230 have been described in detail later with reference to FIG. 5. Furthermore, the various operations of the second rates calculation submodule 232 have been described in detail later with reference to FIG. 6. The rate selection and rules engine 234 is configured to receive the first recommended price records 402 and the second recommended price records 404 from the first rates calculation submodule 230 and the second rates calculation submodule 232, respectively. The rate selection and rules engine 234 is also configured to receive the payor rate overrides 316 and the provider rate overrides 318. In several embodiments, the rate selection and rules engine 234 selects the universally acceptable price records 314 based on precedence-based pricing indicated by a composite group matching key. The processor 206 writes the universally acceptable price record to persistent storage and indexes the record in a database using the composite group matching key to enable deterministic key-based retrieval. The universally acceptable price record includes the composite group matching key and an associated calculated price value corresponding to a defined medical procedure, service, pharmaceutical product, or medical device, wherein the composite group matching key serves as a machine-readable identifier for deterministic indexing and retrieval of the record.

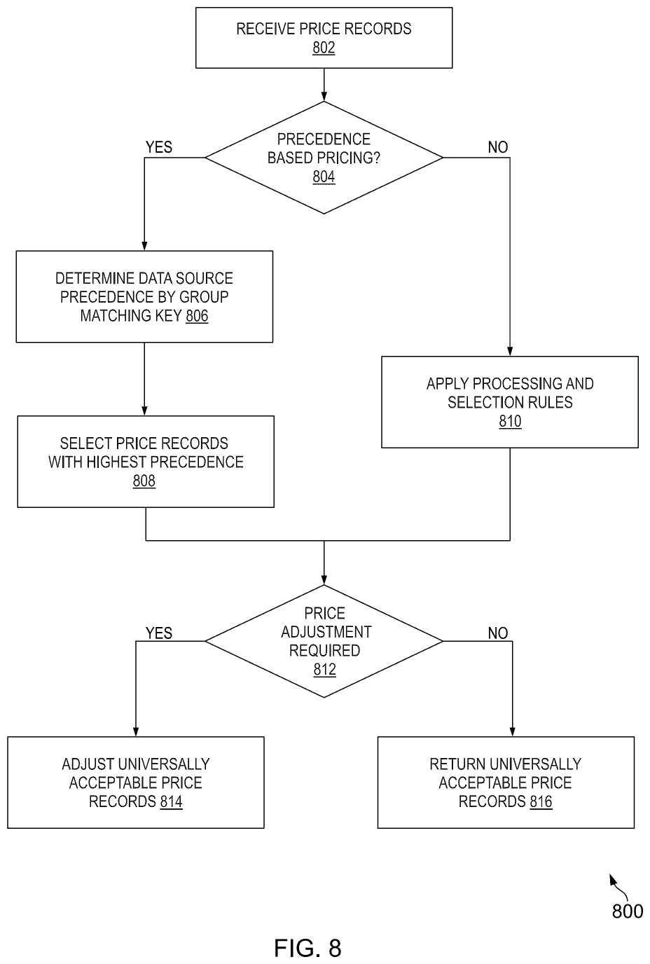

In several alternate embodiments, the rate selection and rules engine 234 applies processing and selection rules on the first recommended price records 402, the second recommended price records 404, the payor rate overrides 316, and the provider rate overrides 318 to generate the universally acceptable price records 314. The precedence-based pricing and the processing and selection rules will be discussed in detail in the following discussion in conjunction with FIG. 8.

The payors have the ability to generate price overrides so that payors have the flexibility to raise and lower rates for specific medical procedures and services as illustrated in the payor rate overrides 316. The providers have similar abilities to generate price overrides so that the providers have the flexibility to raise and lower rates for specific medical procedures and services as illustrated in the provider rate overrides 318. Adjusted pricing for both the payors and the providers enables them to adapt their pricing to market conditions. During processing, the pricing engine applies the override records in accordance with defined precedence or selection rules to adjust, replace, or supersede base price values derived from the statistical price records or direct price records. The resulting adjusted prices are incorporated into the universally acceptable price records and may be exposed through downstream systems, including automated pricing interfaces or electronic price comparison tools, thereby enabling consistent dissemination of the updated price values across connected computing systems.

The RFs 304 (both payor and hospital) and other pricing arrangements 306 directly specify the negotiated rate for each procedure/service. The MRF rates are filtered/post-processed to ensure each facility/provider actually performs the procedure/service specified in the RF. The RFs 304 may include all rates in a contract but not all facilities/providers perform all contracted procedures/services. This is done through a ‘definitively done’ filter (populated based on the claims data 302 and other algorithms). Additional filtering includes outlier/error removal. Once all payor MRFs 304 are filtered, the universally acceptable price is calculated using various methodologies including a weighted average for each payor's claim volume. The resulting average negotiated rate is then used as the direct pricing universally acceptable price. Thus, statistical price records 308 are calculated from the claims data 302 (which can be sparse and stale) while direct price records 310 are calculated directly from current negotiated rates (for all payors) contained within RFs 304, fee schedules, and so on.

For processing and generation of the MRFs 304, the present invention employs a data-parallel, scale-out computing architecture implemented using distributed processing nodes. Incoming MRF datasets are partitioned into multiple data segments and processed concurrently across a cluster of compute resources to enable high-throughput handling of large-scale healthcare pricing data. The architecture supports deployment in colocation data centers as well as cloud-based environments, including infrastructure platforms such as Amazon Web Services (AWS®). Custom data ingestion pipelines perform distributed extract, transform, and load (ETL) operations to automatically parse, validate, normalize, and restructure raw pricing datasets.

The distributed pipeline architecture enables automated processing of petabyte-scale data volumes on a recurring basis and further transforms the raw datasets into structured and reduced price records generated by the restructuring engine. In particular, the system consolidates large and heterogeneous pricing inputs into a smaller set of statistically representative and standardized records while preserving statistical distributions and other characteristics of the underlying data. By reducing the volume of data that must be stored, transmitted, and queried, while maintaining statistical fidelity, the architecture improves storage efficiency, lowers network bandwidth utilization, and enables faster indexing, retrieval, and synchronization across distributed systems. The generalized ETL framework additionally supports structured integration with third-party systems and external datasets, including electronic health record (EHR) systems, through standardized data exchange interfaces and schema normalization layers.

FIG. 5 illustrates a flow diagram depicting a process 500 for determining the first recommended price records 402 from the statistical price records 308, in accordance with an embodiment of the present disclosure. The first rates calculation sub-module 230 of the restructuring engine 228 is configured to determine the first recommended price records 402 for specific medical procedures, services, pharmaceuticals, and medical devices, using the statistical price records 308.

The process 500 begins at Step 502 when the statistical price records 308 are received by the processor 206 and appended to the healthcare management data 218 in the storage device 204. Each statistical price record is associated with one or more dimensions and corresponding keys.

At Step 504, the statistical price records 308 are grouped into a plurality of first record groups based on one or more dimensions and corresponding keys of each statistical record, by the processor 206. A dimension refers to a data attribute or categorical variable associated with a price record that defines a characteristic of the record. The dimension of the record represents a logical grouping criterion and may correspond to an attribute describing the scope or applicability of a price record. A key (interchangeably referred to as “identifier”) refers to a normalized and uniquely identifiable data value corresponding to a given dimension and stored as part of the price record. The processor utilizes the keys as machine-processable identifiers to group, index, associate, or retrieve records. In various embodiments, a composite group matching key is generated by deterministically combining two or more keys associated with respective dimensions of a price record to form a single group identifier.

In various embodiments, the processor 206 can generate a key as a machine-readable identifier corresponding to one or more dimensions of a price record to facilitate structured processing and retrieval. Source data may initially include heterogeneous or human-readable values, such as textual procedure descriptions, provider names, or region-specific identifiers. The processor normalizes these values and converts them into standardized, encoded key values stored in structured data fields. Each key functions as a deterministic, machine-processable identifier that uniquely represents a specific dimension of the record, such as a procedure, provider, facility, or time attribute. By using the key as a machine-readable identifier, the processor 206 enables direct key-based indexing, hashing, and memory addressing operations, thereby eliminating reliance on free-text comparisons and reducing ambiguity in record association. This structured key representation permits efficient grouping, constant-time lookup, and reduced computational overhead, resulting in lower processing latency, minimized input/output operations, and improved scalability when handling large-scale pricing datasets.

The one or more dimensions may include patient (demographic information (age, gender, race, ethnicity), geographic location (country, state, city), insurance information (plan type, provider), medical history (conditions, surgeries, allergies)), provider (type of provider (physician, nurse, therapist), specialty, affiliation with healthcare organizations), encounter (date of service, type of encounter (inpatient, outpatient, emergency), place of service (hospital, clinic, home), reason for visit), diagnosis (ICD-10 codes, severity level), procedure (CPT codes, procedure type, severity), medication (generic name, brand name, dosage, route of administration), time ((year, quarter, month, day), time of day). The one or more keys may include patient ID, encounter ID, provider ID, diagnosis code, procedure code, and medication code. In some embodiments, the composite group matching key for a record group (interchangeably referred to as “group of records”) is generated by concatenating, hashing, or otherwise deterministically combining two or more individual keys to form a unique group identifier identifying a given group of records. For example, to analyze the effectiveness of a new treatment for diabetes, the statistical records may be grouped by patient demographics (age, gender), diagnosis (diabetes type), provider specialty (endocrinology), and encounter type (outpatient). The keys would be patient ID, encounter ID, diagnosis code, and provider ID. In several embodiments, the composite group matching key may be a concatenation of the patient ID, the encounter ID, the diagnosis code, and the provider ID. Records sharing the same composite group matching key are assigned to the same record group for subsequent statistical processing. The grouping operation enables the processor 206 to isolate homogeneous subsets of statistical price records for application of group-specific calculation methods.

The dimensions and keys define the scope of applicability of each record group and determine how first recommended price records are computed. For example, a first recommended price record can be calculated for a composite key derived from MRF files using an all payors MEAN: procedure code, facility NPI, provider NPI. The MRF files themselves define an additional dimension, the payor (e.g. carrier).

The composite group matching key comprises a combination of normalized identifiers that collectively define the scope of applicability of a price, such as a procedure code, facility identifier (e.g., facility NPI), provider identifier (e.g., provider NPI), and optionally additional dimensions including place of service, billing class, or modifiers. Records sharing the same composite key are grouped together such that each group represents a contextually consistent set of pricing observations for the same healthcare service and provider context. This grouping enables the processor to isolate and independently process homogeneous subsets of data rather than applying a single global pricing computation across heterogeneous records.

At Step 506, the processor 206 checks if the last first group has been processed, if yes, the process 500 moves to Step 514 and all the first recommended price records 402 are returned and appended to the healthcare management data 218. Alternately, the process 500 moves to Step 508.

At Step 508, the processor 206 selects a calculation method for the corresponding first record group based on the composite group matching key. For each first record group, the processor 206 determines a calculation method based on the composite group matching key by referencing a stored rule set indexed by key specificity. In particular, the processor 206 performs a hierarchical or longest-matching-prefix evaluation to identify the most specific rule applicable to the group and selects a corresponding aggregation or pricing function. The selected calculation method may include, for example, a minimum, maximum, mean, median, weighted mean, or predictive model-based computation.

At Step 510, the processor applies the selected calculation method independently to records within the first record group to generate a first recommended price record corresponding to each group. The first recommended price record is associated with a corresponding composite group matching key.

In an embodiment, the processor 206 calculates the first recommended price records 402 for each record group by executing a sequence of deterministic data processing operations on the statistical price records associated with the group. The processor 206 first performs pre-processing operations including deduplication of redundant records, validation of field completeness, normalization of identifiers, and standardization of data formats. Missing or invalid values may be imputed, filtered, or replaced according to predefined rules, and relevant variables such as procedure codes, diagnosis codes, provider identifiers, payor identifiers, dates of service, charges, payments, and adjustment values are extracted and stored in structured data fields.

After pre-processing, the processor 206 applies the selected calculation method independently to records within the record group to generate a first recommended price record from the corresponding group. Such operations may include calculating summary statistics such as mean, median, minimum, maximum, standard deviation, volume counts, or weighted averages. The processor 206 may further apply normalization or adjustment factors, including time-based scaling factors, geographic adjustment coefficients, or other predetermined weighting parameters, to account for temporal or regional variation in the data.

For example, when calculating the MEAN for the above key the all payors price database is queried by the key (i.e. the group by key) and a MEAN is calculated for the selected records. To elaborate, if the all payors negotiated rate database had 10 payors in it (provided by 10 MRFs), and each of those MRFs defined the rate for the above key, the MEAN would be calculated for those 10 records and would be stored as a calculated first recommended price record under the above key (in the rate database). In a similar calculation, all payors and all providers MEAN at a facility can be calculated using the following key: procedure code, facility NPI. The above rate can be used when a provider is not known at the facility.

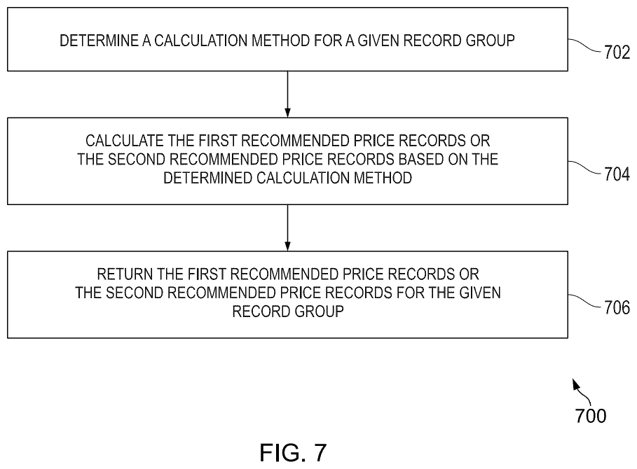

Accordingly, the processor 206 generates first recommended price records 402 and writes them to memory or persistent storage in association with the corresponding composite group matching keys. These generated records provide statistically representative price values for subsequent selection and restructuring operations. By selecting the calculation method as a function of the composite key, the system enables differentiated pricing logic at varying levels of granularity (e.g., provider-specific, facility-specific, or procedure-level), thereby improving accuracy, scalability, and contextual relevance of the resulting universally acceptable price records. More details in regards to the determination of the first recommended price records 402 for the given record group have been discussed in conjunction with FIG. 7 in the following discussion.

At Step 512, the processor 206 appends the first recommended price records 402 to the healthcare management data 218 in the storage device 204.

At Step 514, the processor 206 moves to the next record group and repeats Steps 506, 508, 510, and 512 until all record groups have been covered.

FIG. 6 illustrates a flow diagram depicting a process 600 for determining the second recommended price records 404 from the direct price records 310, in accordance with an embodiment of the present disclosure. The second rates calculation sub-module 232 of the restructuring engine 228 is configured to determine the second recommended price records 404 for specific medical procedures, services, pharmaceuticals, and medical devices, using the direct price records 310.

The process 600 begins at Step 602 when the direct price records 310 are received by the processor 206 and appended to the healthcare management data 218 in the storage device 204. Each direct price record is associated with one or more dimensions and corresponding keys.

At Step 604, the direct price records 310 are grouped into a plurality of second record groups based on one or more dimensions and corresponding keys of each direct record, by the processor 206. The key, dimension, and composite group matching key described with reference to FIG. 6 are similar to those described with reference to FIG. 5. The one or more dimensions may include patient (demographic information (age, gender, race, ethnicity), geographic location (country, state, city), insurance information (plan type, provider), medical history (conditions, surgeries, allergies)), provider (type of provider (physician, nurse, therapist), specialty, affiliation with healthcare organizations), encounter (date of service, type of encounter (inpatient, outpatient, emergency), place of service (hospital, clinic, home), reason for visit), diagnosis (ICD-10 codes, severity level), procedure (CPT codes, procedure type, severity), medication (generic name, brand name, dosage, route of administration), time ((year, quarter, month, day), time of day). The one or more keys may include patient ID, encounter ID, provider ID, diagnosis code, procedure code, and medication code. In several embodiments, the composite group matching key for a second record group (interchangeably referred to as “group of records”) generated by concatenating, hashing, or otherwise deterministically combining two or more individual keys to form a unique group identifier identifying a given group of records. For example, to analyze the effectiveness of a new treatment for diabetes, the direct records may be grouped by patient demographics (age, gender), diagnosis (diabetes type), provider specialty (endocrinology), and encounter type (outpatient). The keys would be patient ID, encounter ID, diagnosis code, and provider ID. The composite group matching key may be a concatenation of the patient ID, the encounter ID, the diagnosis code, and the provider ID. Records sharing the same composite group matching key are assigned to the same record group for subsequent processing. The grouping operation enables the processor 206 to isolate homogeneous subsets of direct price records for application of group-specific calculation methods.

The dimensions and keys define the scope of applicability of each second record group and determine how second recommended price records are computed. For example, a second recommended price record can be calculated for a composite group matching key derived from MRF files using an all payors MEAN: procedure code, facility NPI, provider NPI. The MRF files themselves define an additional dimension, the payor (e.g. carrier).

The composite group matching key comprises a combination of normalized identifiers that collectively define the scope of applicability of a price, such as a procedure code, facility identifier (e.g., facility NPI), provider identifier (e.g., provider NPI), and optionally additional dimensions including place of service, billing class, or modifiers. Records sharing the same composite key are grouped together such that each group represents a contextually consistent set of pricing observations for the same healthcare service and provider context. This grouping enables the processor to isolate and independently process homogeneous subsets of data rather than applying a single global pricing computation across heterogeneous records.

At Step 606, the processor 206 checks if the last second group has been processed, if yes, the process 600 moves to Step 614, and all the second recommended price records 404 are returned and appended to the healthcare management data 218. Alternately, the process 600 moves to Step 608.

At Step 608, the processor selects a calculation method for the corresponding second record group based on the composite group matching key. For each second record group, the processor 206 determines a calculation method based on the composite group matching key by referencing a stored rule set indexed by key specificity. In particular, the processor 206 performs a hierarchical or longest-matching-prefix evaluation to identify the most specific rule applicable to the group and selects a corresponding aggregation or pricing function. The selected calculation method may include, for example, a minimum, maximum, mean, median, weighted mean, or predictive model-based computation.

At Step 610, the processor 206 applies the selected calculation method independently to records within the second record group to generate a second recommended price record corresponding to each group. Each second recommended price record is associated with a corresponding composite group matching key.

In an embodiment, the processor 206 calculates the second recommended price records 404 for each record group by executing a sequence of deterministic data processing operations on the direct price records associated with the group. The processor 206 first performs pre-processing operations including deduplication of redundant records, validation of field completeness, normalization of identifiers, and standardization of data formats. Missing or invalid values may be imputed, filtered, or replaced according to predefined rules, and relevant variables such as procedure codes, diagnosis codes, provider identifiers, payor identifiers, dates of service, charges, payments, and adjustment values are extracted and stored in structured data fields.

After pre-processing, the processor 206 applies the selected calculation method independently to records within the record group to generate a second recommended price record for the corresponding group. Such operations may include calculating summary statistics such as mean, median, minimum, maximum, standard deviation, volume counts, or weighted averages. The processor 206 may further apply normalization or adjustment factors, including time-based scaling factors, geographic adjustment coefficients, or other predetermined weighting parameters, to account for temporal or regional variation in the data.

Accordingly, the processor 206 generates second recommended price records 404 and writes them to memory or persistent storage in association with the corresponding composite group matching keys. These generated records provide representative price values for subsequent selection and restructuring operations. By selecting the calculation method as a function of the composite key, the system enables differentiated pricing logic at varying levels of granularity (e.g., provider-specific, facility-specific, or procedure-level), thereby improving accuracy, scalability, and contextual relevance of the resulting universally acceptable price records. More details in regards to the determination of the second recommended price records 404 for the given second record group have been discussed in conjunction with FIG. 7 in the following discussion.

At Step 612, the processor 206 appends the second recommended price records 404 to the healthcare management data 218 in the storage device 204.

At Step 614, the processor 206 moves to the next record group and repeats Steps 606, 608, 610, and 612 until all record groups have been covered.

FIG. 7 illustrates a flow diagram depicting a process 700 for determining the first recommended price records 402 or the second recommended price records 404 for a given record group, in accordance with an embodiment of the present disclosure. The several steps of the process 700 are envisaged to be performed by the processor 206. The process 700 may be applied by the processor 206 at Step 508 and 510 of process 500 and/or at Steps 608 and 610 of process 600.

At step 702, the processor 206 determines a calculation method for the given record group to generate the first recommended price records 402 in the process 500 or the second recommended price records 404 in the process 600. The calculation method can be determined on the basis of several factors such as a given dimension, a given key, or a group matching key generated from combining one or more individual keys in a given record group. The calculation method can be any function operating over a group of records but typically is one of MEAN, WEIGHTED_MEAN, MEDIAN, MIU, MAX, PREDICTIVE, etc.

TABLE 1 presents an example set of database variables that are used in the process of determining the first recommended price records 402 and/or the second recommended price records 404.

TABLE 1

| FIELD | NAME | UNIT | DEFINITION |
|---|---|---|---|
| ID | CALCULATION | UNIQUE ID | UNIQUE |
| | RECORD ID | | CALCULATION ID |
| START_DATE_TIME | START DATE TIME | MILLISECONDS | UNIX TIMESTAMP |
| | | | IN MILLISECONDS |
| | | | SINCE THE EPOCH |
| DURATION | DURATION | MILLISECONDS | ACTIVE DURATION |
| | | | IN MILLISECONDS |
| | | | AFTER START |
| | | | DATE TIME |
| CALCULATION | CALCULATION | STRING | CALCULATION |
| | METHOD | | METHOD |
| | | | IDENTIFIER |
| KEY | CALCULATION | UNIQUE GROUP | CALCULATION |
| | GROUP MATCHING | KEY | GROUP MATCHING |
| | KEY | | KEY |

Fields in the TABLE 1 include an ID, a start date time, an active duration, a calculation, and a key. The field “ID” represents the calculation record Identity (ID) and indicates a unique record ID for each calculation description. The field “start date time” represents the timestamp in milliseconds for a predetermined time period (e.g., epoch) and indicates the date and time the calculation is activated (i.e., the date and time of activating the calculation). The field “calculation” represents an identifier of the calculation method and indicates how long the calculation is active after the start date time. The calculation method indicates the type of group calculation that needs to be used for a group that matches the composite group matching key. The field “key” represents the composite group matching key.

The recording of the calculation start time and its associated duration has technical significance in defining the temporal validity of the calculation within the system. Specifically, the start date time establishes the exact moment from which a particular calculation method becomes active, while the calculation identifier determines the length of time for which the calculation remains effective. Together, these parameters define a time-bound interval during which the calculation is executed and the resulting output (e.g., pricing or rates) is considered valid. This temporal control enables the system to automatically apply different calculations over time, for example to reflect changes in contractual terms, pricing models, or calculation methodologies, without manual intervention.

At Step 704, once the calculation method is determined, the calculation method is applied to the record group, by the processor 206, to calculate the first recommended price records 402 or the second recommended price records 404.

At Step 706, the first recommended price records 402 or the second recommended price records 404 are returned depending upon if the process 500 is active or process 600 is active.

FIG. 8 illustrates a flow diagram depicting a process 800 for selecting the universally acceptable price records 314 from the first recommended price records 402, the second recommended price records 404, the payor rate overrides 316 and the provider rate overrides 318 as, in accordance with an embodiment of the present disclosure. The steps disclosed in the process 800 are performed by the rate selection and rules engine of the processor 206. In several embodiments, the rate selection and rules engine 234 selects the universally acceptable price records 314 based on precedence-based pricing indicated by a composite group matching key. In several alternate embodiments, the rate selection and rules engine 234 applies processing and selection rules on the first recommended price records 402, the second recommended price records 404, the payor rate overrides 316, and the provider rate overrides 318 to generate the universally acceptable price records 314.

The process 800 begins at Step 802 when calculated and accessed price records are received by the processor 206. The calculated price records include the first recommended price records 402 and the second recommended price records 404. The accessed price records include the payor rate overrides 316 and the provider rate overrides 318.

At Step 804, the processor 206 determines if precedence-based pricing is applicable. If precedence-based pricing is applicable, the process 800 moves to Step 806, otherwise the process 800 moves to Step 810 where the processing and selection rules are applied by the processor 206.

In an embodiment, precedence-based pricing is not applied by default and is determined by system configuration. Specifically, the system first checks whether precedence-based pricing has been enabled in the pricing configuration. When enabled, the configuration uses defined group-matching keys to associate a transaction or entity with a corresponding pricing configuration (as illustrated in Table 2). If the selected pricing configuration specifies precedence-based pricing, the system applies the corresponding precedence rules defined for that configuration. Otherwise, standard pricing logic is applied.

At Step 806, processor 206 determines data source precedence by composite group matching key. Some examples of the data sources include the first recommended price records 402, the second recommended price records 404, the payor rate overrides 316 and the provider rate overrides 318.

At step 808, upon determining which data source takes precedence for the given composite group matching key, the highest precedence price records are selected as the universally acceptable price records 314. For example, the default order of precedence includes, firstly the payor rate overrides 316, secondly the provider rate overrides 318, the second recommended price records 404 calculated from the direct price records 310, and then the first recommended price records 402 generated from the statistical price records 308. For example, a payor may force the rate that the payor is willing to pay for a given service at a given location. In a scenario, when the payor override does not exist, the provider may force their acceptable rate (i.e., the provider override). Finally, when both payor and provider overrides are not present, the second recommended price records 404 are used. In a scenario, when the payor and provider overrides and the second recommended price records 404 are not available, the first recommended price records 402 are used. It should be noted that the data source precedence order is controlled by the order specified by the composite group matching key in TABLE 2.

TABLE 2

| FIELD | NAME | UNIT | DEFINITION |
|---|---|---|---|
| ID | PRECEDENCE | UNIQUE ID | UNIQUE |
| | RECORD ID | | PRECEDENCE |
| | | | RECORD ID |
| START_DATE_TIME | START DATE TIME | MILLISECONDS | UNIX TIMESTAMP |
| | | | IN MILLISECONDS |
| | | | SINCE THE EPOCH |
| DURATION | DURATION | MILLISECONDS | ACTIVE DURATION |
| | | | IN MILLISECONDS |
| | | | AFTER START DATE |
| | | | TIME |
| DATA_SOURCE | DATA SOURCE | STRING | DATA SOURCE |
| | | | IDENTIFIER |
| PRECEDENCE | PRECEDENCE | INTEGER | RATE SELECTION |
| | | | PRECEDENCE |
| KEY | PRECEDENCE | UNIQUE GROUP | PRECEDENCE |
| | GROUP MATCHING | KEY | GROUP MATCHING |
| | KEY | | KEY |

Alternately, at Step 810, the processor 206 applies processing and selection rules to determine the universally acceptable price records 314. For example, a record group may be uniquely identifiable by a composite group matching key with three individual keys: procedure code, facility NPI, and provider NPI. In this case four levels of processing and selection rules may be specified, viz., no key (the processing and selection rules at this level apply to all keys), procedure code (the processing and selection rules at this level apply to the specified procedure code, all facility NPIs and provider NPIs), procedure code, facility NPI (the processing and selection rules at this level to the specified procedure code, the specified facility NPI and all provider NPIs), and procedure code, facility NPI, provider NPI (the processing and selection rules at this level apply to the specified procedure code, the specified facility, and the specified provider at that facility). Once the set of the processing and selection rules have been determined by longest matching prefix (the group by the key), they are executed. Example processing rules are given in TABLE 3.

TABLE 3

| | START_DATE_ | | | |
|---|---|---|---|---|
| ID | TIME | DURATION | CALCULATION | KEY |
| 1 | 0 | MAX_LONG | WEIGHTED_MEAN | |
| 2 | 0 | MAX_LONG | MEAN | procedure code 1 |
| 3 | 0 | MAX_LONG | MEDIAN | procedure code 1, |
| | | | | facility npi 1 |
| 4 | 0 | MAX_LONG | MIN | procedure code 1, |
| | | | | facility npi 1, provider |
| | | | | npi 1 |

In TABLE 3, ID #4 is the most specific, longest matching key for procedure code 1, facility NPI 1, and provider NPI 1, MIN will be aggregation function applied for the matching rates. In other words, provider 1 at facility 1 will be paid the minimum contracted rate for procedure 1 determined from all contract negotiations. Next, based on IID #3, for all other providers, procedure code 1 will use the MEDIAN of all contract negotiations at facility 1. IID #2 indicates procedure code 1 will have a universally acceptable price record calculated using the MEAN across all payors. ID #1 specifies the default, non-matching rule to be WEIGHTED_MEAN.

Example selection rules are given in TABLE 4.

TABLE 4

| | START_DATE_ | | | | |
|---|---|---|---|---|---|
| ID | TIME | DURATION | DATA_SOURCE | PRECEDENCE | KEY |
| 1 | 0 | MAX_LONG | Statistical Price | 3 | |
| | | | Records | | |
| 2 | 0 | MAX_LONG | Direct Price | 0 | |
| | | | Records | | |
| 3 | 0 | MAX_LONG | Payor Rate | 1 | |
| | | | Overrides | | |
| 4 | 0 | MAX_LONG | Provider Rate | 2 | |
| | | | Overrides | | |
| 5 | 0 | MAX_LONG | Statistical Price | 0 | procedure code 1 |
| | | | Records | | |
| 6 | 0 | MAX_LONG | Payor Rate | 0 | procedure code 1, |
| | | | Overrides | | facility npi 1 |
| 7 | 0 | MAX_LONG | Provider Rate | 0 | procedure code 1, |
| | | | Overrides | | facility npi 1, |
| | | | | | provider npi 1 |
| 8 | 0 | MAX_LONG | Direct Price | 1 | procedure code 1, |
| | | | Records | | facility npi 1, |
| | | | | | provider npi 1 |

Note: 0 is the highest precedence. In TABLE 4, ID #1-4 specify the non-specific (i.e. no key matches) data source preference for all data sources. In this example the data source precedence is Direct Price Records (0) then Payor Rate Overrides (1) then Provider Rate Overrides (2) then Statistical Price Records (3). IID #5 applies to all records with procedure code 1 (without additional key matching) and indicates only Statistical Price Records (0) should be used for procedure code one. ID #6 applies to procedure code 1 at facility 1 and indicates only Payor Rate Overrides are to be used. ID #7-8 applies to procedure code 1 at facility 1 for provider 1 and indicates Provider Rate Overrides (0) should be used when specified and then Direct Price Records (0).

At Step 812, the processor 206 checks whether the price adjustment of the selected universally acceptable price records 314 is required or not. The price adjustments can be global and can also be specified by the composite group matching key. Upon determining an adjustment is required, the adjustment of the universally acceptable price records 314 is performed as at step 814. The base universally acceptable price records 314 are adjusted by the specification of percentage adjustments. The rates may be adjusted above (or below) the rates determined for payors or providers.

Alternately if no adjustment is required, at Step 816, the selected universally acceptable price records are returned to complete the process 800.

It should be noted that all data in the server system 200 is updated on an ongoing basis with versioned data releases at least once a month. For example, the claims data 302 is obtained and updated daily but the statistical price records are calculated for a specified date range, are versioned, and contain valid start and stop dates (also referred to as the validity interval). The precedence rules are defined between the statistical price records 308, the direct price records 310, the payor rate overrides 316, and the provider rate overrides 318, and the rules contain start and stop (activation/deactivation) date ranges (i.e., the validity interval). Since all data and rules are versioned and dated, consistency is maintained per data release. Each release can be reproduced by using the versioned data, date ranges, and versioned rules.

Fields in the Table 2 include an ID, a start date time, a duration, a data source, precedence, and a key. The field “ID” represents a unique precedence record ID and indicates a unique record ID for each precedence rule. The field “start date time” represents a timestamp in milliseconds over a period of time (e.g., epoch) and indicates the date and time of activation of the rule (i.e., the activation date and time of the rule). The field “duration” represents the active duration in milliseconds after the start date and time and indicates how long the rule is active after the start date and time. The field “precedence” represents rate selection precedence. The field “key” represents precedence group matching. The field “data source” represents the data source identifier and indicates the data source to which the rate selection precedence is applied by matching the group indicated by the composite group matching key.

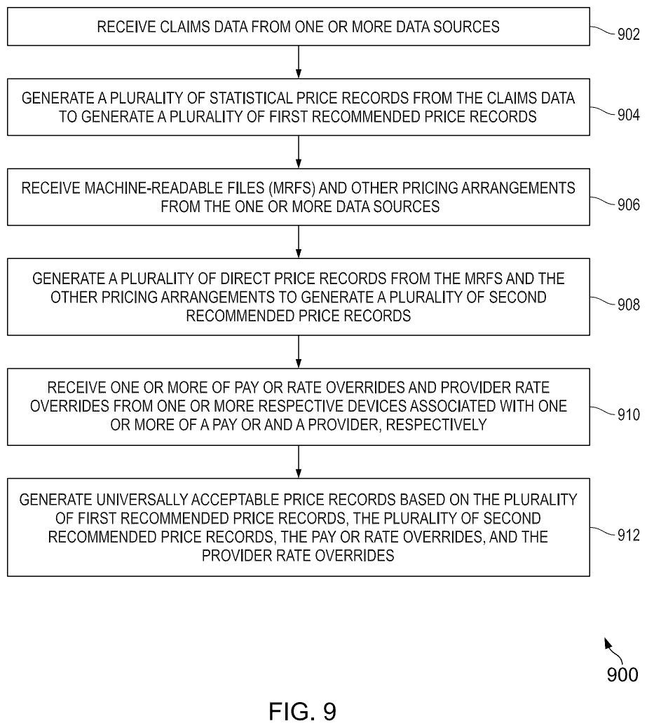

FIG. 9 illustrates a flow diagram of a computer-implemented method 900 for restructuring price records while preserving statistical distributions, in accordance with an embodiment of the present disclosure. The method 900 depicted in the flow diagram may be executed by, for example, the server system 200. Operations of the flow diagram of the method 900, and combinations of the operations in the flow diagram of the method 900, may be implemented by, for example, hardware, firmware, a processor, circuitry, and/or a different device associated with the execution of software that includes one or more computer program instructions. It is noted that the operations of the method 900 can be described and/or practiced by using a system other than the server system 200. The method 900 starts at operation 902.

At operation 902, the method 900 includes receiving, by the server system 200, claims data from one or more data sources and generating statistical price records from the claims data.

At operation 904, the method 900 includes generating, by the server system, a plurality of statistical price records from the claims data to generate a set of first recommended price records. The set of first recommended price records are generated by: grouping the plurality of statistical price records into a plurality of first record groups according to a composite group matching key, selecting, for each first record group, a calculation method based on the composite group matching key; and applying the selected calculation method to records within the corresponding first record group to generate the set of first recommended price records from the plurality of statistical price records. The composite group matching key for a first record group is generated by combining one or more identifiers associated with each statistical price record within the corresponding first record group

At operation 906, the method 900 includes receiving, by the server system, Machine-Readable Files (MRFs) and other pricing arrangements from the one or more data sources.

At operation 908, the method 900 includes generating, by the server system, a plurality of direct price records from the MRFs and the other pricing arrangements to generate a set of second recommended price records. The set of second recommended price records are generated by: grouping the plurality of direct price records into a plurality of second record groups according to a composite group matching key, selecting, for each second record group, a calculation method based on the composite group matching key; and applying the selected calculation method independently to the records within the corresponding second record group to generate the set of second recommended price records from the plurality of direct price records. The composite group matching key for a second record group is generated by combining one or more identifiers associated with each direct price record within the corresponding second record group.

At operation 910, the method 900 includes receiving, by the server system 200, one or more of payor rate overrides and provider rate overrides from one or more respective devices associated with one or more of a payor and a provider, respectively.

At operation 912, the method 900 includes generating, by the server system 200, universally acceptable price records based on the set of first recommended price records, the set of second recommended price records, the payor rate overrides, and the provider rate overrides. The one or more operations for determining the universally acceptable price records are explained above, therefore they are not reiterated herein for the sake of brevity.

The disclosed processes 500, 600, 700, 800, 900 with reference to FIGS. 5 to 9, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers.

Thus, the present invention establishes the universally acceptable price records for every medical procedure performed nationwide. The universally acceptable price records are specific to facilities and providers. The universally acceptable price records correspond to a rate acceptable by the facilities and providers, as it is based on payments that are currently accepted by the facilities and providers. Thus, the present invention improves the efficiency, scalability, and reliability of healthcare pricing data processing by transforming heterogeneous pricing datasets into standardized and statistically representative price records that enable deterministic grouping, rapid key-based retrieval, reduced storage overhead, and automated transactional validation across distributed computing systems.

Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including Radio Frequency (RF), microwave, and infrared communications), electronic communications, or other such communication means.

Various embodiments of the present disclosure provide significant technical improvements in the processing of large-scale healthcare pricing datasets. In particular, heterogeneous and high-volume pricing data originating from multiple sources, including machine-readable files and negotiated rate repositories, are normalized, grouped, and transformed into standardized and statistically representative price records. By restructuring raw datasets into a reduced set of universally acceptable price records while preserving statistical distributions of the underlying data, the disclosed techniques substantially decrease the volume of records that must be stored, indexed, and processed, thereby improving memory utilization and reducing storage overhead without sacrificing data fidelity.

Another advantage of the disclosed system is improved computational efficiency through deterministic grouping and indexing mechanisms. The generation of composite group matching keys and the construction of key-addressable index structures enable constant-time or near constant-time retrieval of relevant price records, thereby avoiding full-table scans and reducing processor cycles and input/output operations. These optimizations allow the system to service pricing and transaction requests with lower latency and higher throughput, even when operating on datasets derived from petabyte-scale source inputs.

Further advantages arise from the distributed and scalable architecture of the processing pipeline. The data-parallel, scale-out design enables partitioning of incoming datasets and concurrent execution across multiple compute nodes, facilitating automated processing of extremely large volumes of data on a recurring basis. By transmitting only the reduced universally acceptable price records to remote systems rather than complete raw datasets, the architecture minimizes network bandwidth consumption, accelerates cache synchronization, and enables efficient replication of pricing data across distributed environments while maintaining consistency among nodes.

Additional technical benefits are realized during downstream transactional operations. Because the universally acceptable price records are structured, machine-readable, and deterministically derived, they can be directly integrated into automated workflows, including rapid price lookup, validation, payment instruction generation, and transaction integrity enforcement. The ability to programmatically compare submitted prices with retrieved records and automatically abort inconsistent transactions enhances data consistency and system reliability while reducing manual intervention. Collectively, these improvements provide a scalable, efficient, and robust computing framework for managing and applying large-scale pricing data in distributed healthcare information systems.

Although the invention has been described with reference to specific exemplary embodiments, it is to be noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein.

In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which, are disclosed. Therefore, although the invention has been described based on these exemplary embodiments, it is to be noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system, claims data from one or more data sources; and
generating, by the server system, a plurality of statistical price records from the claims data to generate a set of first recommended price records, wherein the set of first recommended price records are generated by:
grouping the plurality of statistical price records into a plurality of first record groups according to a composite group matching key, wherein the composite group matching key for a first record group is generated by combining one or more identifiers associated with each statistical price record within the corresponding first record group;
selecting, for each first record group, a calculation method based on the composite group matching key; and
applying the selected calculation method to records within the corresponding first record group to generate the set of first recommended price records from the plurality of statistical price records;
receiving, by the server system, Machine-Readable Files (MRFs) and other pricing arrangements from the one or more data sources, and
generating, by the server system, a plurality of direct price records from the MRFs and the other pricing arrangements to generate a set of second recommended price records, wherein the set of second recommended price records are generated by:
grouping the plurality of direct price records into a plurality of second record groups according to a composite group matching key, wherein the composite group matching key for a second record group is generated by combining one or more identifiers associated with each direct price record within the corresponding second record group;
selecting, for each second record group, a calculation method based on the composite group matching key; and
applying the selected calculation method independently to the records within the corresponding second record group to generate the set of second recommended price records from the plurality of direct price records;
receiving, by the server system, one or more of payor rate overrides and provider rate overrides from one or more respective devices associated with one or more of a payor and a provider, respectively; and
generating, by the server system, universally acceptable price records based on the set of first recommended price records, the set of second recommended price records, the payor rate overrides, and the provider rate overrides.

2. The computer-implemented method as claimed in claim 1, further comprising transmitting, by the server system, only the universally acceptable price records to remote nodes to synchronize distributed pricing caches while avoiding transfer of raw datasets.

3. The computer-implemented method as claimed in claim 1, further comprising indexing, by the server system, the universally acceptable price records by the composite group matching key to enable constant-time key-based retrieval.

4. The computer-implemented method as claimed in claim 1, further comprising scanning, by the server system, the universally acceptable price records corresponding to a composite group matching key identified based on a user request.

5. The computer-implemented method as claimed in claim 1, further comprising automatically facilitating, by the server system, a payment transaction by generating a machine-readable payment instruction message comprising a payable amount derived from the universally acceptable price records and transmitting the payment instruction message to a payment processing system for execution.

6. The computer-implemented method as claimed in claim 1, further comprising aborting, by the server system, a transaction upon detection of a mismatch between a submitted price included in a transaction request received by the server system and a universally acceptable price retrieved from the universally acceptable price records.

7. The computer-implemented method as claimed in claim 1, wherein the universally acceptable price records comprise universally acceptable Healthcare Service Provider (HSP) price records and universally acceptable pharmacy price records, and the universally acceptable HSP price records and universally acceptable pharmacy price records are used, by the server system, to generate universally acceptable prices based MRFs.

8. The computer-implemented method as claimed in claim 1, wherein the server system selects the universally acceptable price records based on precedence-based pricing indicated by the composite group matching key, wherein the composite group matching key is a combination of one or more individual keys.

9. The computer-implemented method as claimed in claim 1, wherein the server system selects the universally acceptable price records by applying processing and selection rules on the set of first recommended price records, the set of second recommended price records, the payor rate overrides, and the provider rate overrides.

10. The computer-implemented method as claimed in claim 9, wherein the server system applies the processing and selection rules at a plurality of levels depending upon a number of individual keys in a respective composite group matching key identifying an individual record group, wherein the composite group matching key is a combination of one or more individual keys.

11. A server system, comprising:
a processor, and
a memory unit comprising machine-readable instructions, the machine-readable instructions when executed by the processor, cause the server system to at least:
receive claims data from one or more data sources; and
generate a plurality of statistical price records from the claims data to generate a set of first recommended price records, wherein the set of first recommended price records are generated by:
grouping the plurality of statistical price records into a plurality of first record groups according to a composite group matching key, wherein the composite group matching key for a first record group is generated by combining one or more identifiers associated with each statistical price record within the corresponding first record group;
selecting, for each first record group, a calculation method based on the composite group matching key; and
applying the selected calculation method to records within the corresponding first record group to generate the set of first recommended price records from the plurality of statistical price records;
receive Machine-Readable Files (MRFs) and other pricing arrangements from the one or more data sources, and
generate a plurality of direct price records from the MRFs and the other pricing arrangements to generate a set of second recommended price records, wherein the set of second recommended price records are generated by:
grouping the plurality of direct price records into a plurality of second record groups according to a composite group matching key, wherein the composite group matching key for a second record group is generated by combining one or more identifiers associated with each direct price record within the corresponding second record group;
selecting, for each second record group, a calculation method based on the composite group matching key; and
applying the selected calculation method independently to the records within the corresponding second record group to generate the set of second recommended price records from the plurality of direct price records;
receive one or more of payor rate overrides and provider rate overrides from one or more respective devices associated with one or more of a payor and a provider, respectively; and
generate universally acceptable price records based on the set of first recommended price records, the set of second recommended price records, the payor rate overrides, and the provider rate overrides.

12. The server system as claimed in claim 11, wherein the server system is further caused to transmit only the universally acceptable price records to remote nodes to synchronize distributed pricing caches while avoiding transfer of raw datasets.

13. The server system as claimed in claim 11, wherein the server system is further caused to index the universally acceptable price records by the composite group matching key to enable constant-time key-based retrieval.

14. The server system as claimed in claim 11, wherein the server system is further caused to scan the universally acceptable price records corresponding to a composite group matching key identified based on a user request.

15. The server system as claimed in claim 11, wherein the server system is further caused to automatically facilitate a payment transaction by generating a machine-readable payment instruction message comprising a payable amount derived from the universally acceptable price records and transmitting the payment instruction message to a payment processing system for execution.

16. The server system as claimed in claim 11, wherein the server system is further caused to abort the transaction upon detection of a mismatch between the submitted price included in a transaction request received by the server system and a universally acceptable price retrieved from the universally acceptable price records.

17. The server system as claimed in claim 11, wherein the universally acceptable price records comprise universally acceptable Healthcare Service Provider (HSP) price records and universally acceptable pharmacy price records, and the universally acceptable HSP price records and universally acceptable pharmacy price records are used, by the server system, to generate universally acceptable prices based MRFs.

18. The server system as claimed in claim 11, wherein the server system selects the universally acceptable price records based on precedence-based pricing indicated by the composite group matching key, wherein the composite group matching key is a combination of one or more individual keys.

19. The server system as claimed in claim 11, wherein the server system selects the universally acceptable price records by applying processing and selection rules on the first recommended price records, the second recommended price records, the payor rate overrides, and the provider rate overrides.

20. The server system as claimed in claim 19, wherein the server system applies the processing and selection rules at a plurality of levels depending upon a number of individual keys in a respective composite group matching key identifying an individual record group, wherein the composite group matching key is a combination of one or more individual keys.
